(19) United States
(12) Patent Application Publication
(10) Pub. No.: US 2025/0313919 A1
(43) Pub. Date: Oct. 9, 2025

(54) SYSTEMS AND METHODS TO EXTRACT CRITICAL MINERALS FROM PRE-CONCENTRATES PREPARED FROM ACID MINE DRAINAGE

(71) Applicant: West Virginia University Board of Governors on Behalf of West Virginia University, Morgantown, WV (US)

(72) Inventors: Tommee Larochelle, Morgantown, WV (US); Harry O. Finklea, Morgantown, WV (US)

(21) Appl. No.: 18/863,437

(22) PCT Filed: May 9, 2023
(86) PCT No.: PCT/US2023/021564

§ 371 Date: Nov. 6, 2024

Related U.S. Application Data
(60) Provisional application No. 63/339,881, filed on May 9, 2022.

(51) Int. Cl. C22B 59/00; C22B 3/10; C22B 3/22; C22B 3/44

(52) U.S. Cl. CPC C22B 59/00; C22B 3/10; C22B 3/22; C22B 3/44

(57) ABSTRACT

In one aspect, the disclosure relates to relates to systems and methods for the separation and recovery of rare earth elements and other critical minerals from AMD-based pre-concentrate materials, e.g., a solid pre-concentrate material, that provides reduced extraction of silicates from the AMD-based pre-concentrate materials, has a lowered acid consumption, and further removes impurities while retaining the desired rare earth elements and critical metals. Also disclosed are pregnant leach solutions prepared using the disclosed methods. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/339,881, filed on May 9, 2022, which is incorporated herein by reference in its entirety.

### STATEMENT REGARDING FEDERALLY SPONSORED RESEARCH

This disclosure was made with U.S. Government support under grant number DE-FE0031834, awarded by the Department of Energy. The U.S. government has certain rights in the disclosure.

### BACKGROUND

Rare earth elements (REEs) are useful and necessary for the manufacture of batteries that power hybrid and electric vehicles, catalytic converters, computer memory, fluorescent lighting and lasers, smartphones and tablet computers, cameras including electronic components and lenses, e-readers, magnets, night-vision goggles, GPS and communications equipment, military applications including precision-guided weapons and vehicle armor, aircraft engines, personal protective equipment, and in other applications including defense applications. Some REEs can be used in air pollution control mechanisms, oil refineries, in medical diagnostic equipment such as, for example, X-ray and MRI machines, as phosphors, as catalysts, as components of ceramics and paints, and/or as polishing compounds. Although REEs and critical minerals (CM) can be extracted from many waste products and ores, few such resources are economically attractive. Due to current and possibly continuing export controls for REEs from China, it would be desirable to develop domestic sources of REEs.

Acid mine drainage (AMD) is a pollutant generated by coal and other mines and must be treated in compliance with federal and state clean water regulations to adjust pH and remove metal ions including iron, aluminum, and manganese. There are vast instances of acid mine drainage (AMD) in the northern, central, and southern Appalachian basins, as well as the Illinois coal basin and elsewhere in the U.S. Across the northern and central Appalachian Coal Basins, water pollution caused by AMD is the single greatest cause of stream impairment. Processes for treating AMD for regulatory compliance have been the subject of massive research and infrastructure investments since the early 1970s. It is estimated that, in the Appalachian states alone, more than 50 new, large AMD treatment plants will be installed in the next 10 years, in an effort to address increasing stream pollution. Although trace amounts of REEs are known to exist in AMD, a reliable method of concentrating and extracting them has only recently been described, e.g., see U.S. patents application Ser. Nos. 16/795,471, 17/115,128, and 17/706,584, as well as Intl. Pat. Appl. No. PCT/US2020/042674.

Despite advances in the treatment of acid mine drainage, and methods of concentrating and extracting rare earth elements and critical metals from same, there remains a need for further improvements of handling feedstreams produced from these sources, e.g., further processing of AMD-based pre-concentrate materials that has a low acid consumption, limited silica leaching, and further removes impurities while retaining the desired rare earth elements and critical metals. These needs and other needs are satisfied by the present disclosure.

### SUMMARY

In accordance with the purpose(s) of the disclosure, as embodied and broadly described herein, the disclosure, in one aspect, relates to systems and methods for the separation and recovery of rare earth elements and other critical minerals from AMD-based pre-concentrate materials, e.g., a solid pre-concentrate material, that provides reduced extraction of silicates from the AMD-based pre-concentrate materials, has a lowered acid consumption, and further removes impurities while retaining the desired rare earth elements and critical metals.

Disclosed are methods for preparing a pregnant leach solution, the method comprising: providing a pre-concentrate; adding an acid to the pre-concentrate; mixing the acid and the pre-concentrate thereby forming an acid leached solution; adding water to the acid leached solution; mixing the water and the acid leached solution, thereby forming a water leached solution; adding a pre-neutralization base to the water leached solution thereby forming a pre-neutralization solution; separating the pre-neutralization solution into a pre-neutralization solids material and a pre-neutralization liquid; adding a neutralization base to the pre-neutralization liquid thereby forming a neutralization solution; and separating the neutralization solution into a neutralization solids material and a pregnant leach solution, thereby providing the pregnant leach solution.

Also disclosed are pregnant leach solutions prepared using the disclosed methods.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B show aspects of the disclosed process for preparation of a pregnant leach solution from an AMD-derived pre-concentrate. FIG. 1A shows a general process flow for the disclosed process for preparation of a pregnant leach solution from an AMD-derived pre-concentrate. FIG. 1B shows a more particular process flow for the disclosed process for preparation of a pregnant leach solution from an AMD-derived pre-concentrate.

FIGS. 2A-2B show composition information for an exemplary AMD-derived pre-concentrate used in the preparation of a pregnant leach solution as described in the Examples. FIG. 2A shows the amounts of various components (wt %) in the AMD-derived pre-concentrate. As shown in FIG. 2A, AMD-derived pre-concentrate comprised approximately 28 wt % gangue metals, 7 wt % silicon, and 1 wt % total rare earth elements (TREE). FIG. 2B shows specific levels (wt %) of the components of the TREE.

FIGS. 3A-3B show composition information for an exemplary pregnant leach solution prepared by the disclosed methods and as described in the Examples. FIG. 3A shows the amounts of various components present in the pregnant leach solution. The amounts are given as a percentage, based on mass balance, of the indicated material present in the pregnant leach solution compared to the amount found in the pre-concentrate used in the study. The data indicated that about 60%-80% of gangue elements (Al, Ca, Fe, Mg, Mn, Zn), 1% of the silicates (FIG. 4A), and about 70%-90% of the TREEs were present in the pregnant leach solution based on the amounts present in the pre-concentrate used. FIG. 3B shows the amounts of the various components of the TREE in the pregnant leach solution.

FIG. 4 shows an exemplary scheme for conveyance of pre-concentrate material from a plurality of acid mine drainage sites to a leach reactor for entry into the disclosed processes and methods.

FIG. 5 shows an exemplary scheme for conveyance of pre-concentrate material from the preceding figure to a feed silo and subsequent steps from the feed silo through acid leaching processing of the acid treated pre-concentrate to a pug mill.

FIG. 6 shows an exemplary scheme for steps of the disclosed processes and methods from a pug mill (from the preceding scheme in FIG. 5) to conveying leach residue to a water leach unit to thermal fluid return.

FIG. 7 shows an exemplary scheme for steps of the disclosed processes and methods from a leached concentrate silo (from the preceding scheme in FIG. 6) to conveying a water leached solution to pre-neutralization.

FIG. 8 shows an exemplary scheme for steps of the disclosed processes and methods from conveyance of a water leached solution (from the preceding scheme in FIG. 7) to a pre-neutralization tank, pre-neutralization, and the like as shown to conveying a pre-neutralization solution to neutralization.

FIG. 9 shows an exemplary scheme for steps of the disclosed processes and methods from conveyance of a pre-neutralization solution (from the preceding scheme in FIG. 8) to a neutralization tank, neutralization, and the like as shown to conveying a neutralization solution to centrifugation.

FIG. 10 shows an exemplary scheme for steps of the disclosed processes and methods from conveyance of a neutralization solution (from the preceding scheme in FIG. 9) to a centrifugation step, filtration, and the like as shown to conveying a pregnant leach solution to further processing.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a rare earth element” includes, but is not limited to, mixtures of two or more such rare earth elements, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a buffer refers to an amount that is sufficient to achieve the desired improvement in the property modulated by the formulation component, e.g. achieving and maintaining a desired solution pH. The specific level in terms of wt % in a composition required as an effective amount will depend upon a variety of factors including the amount and type of buffer, size of processing plant (i.e., bench top, mobile, or commercial scale), amount and type of feedstock being treated, and end use of the REEs recovered during the process.

As used herein, the terms “optional” or “optionally” means that the subsequently described event or circumstance can or cannot occur, and that the description includes instances where said event or circumstance occurs and instances where it does not.

As used herein, the term “rare earth element” (REE) is refers to a composition comprising one or more rare earth elements, including one or more of a lanthanide chemical element, i.e., lanthanum, cerium, praseodymium, neodymium, promethium, samarium, europium, gadolinium, terbium, dysprosium, holmium, erbium, thulium, ytterbium, lutetium. and can sometimes also include the elements scandium and yttrium. The elements scandium and yttrium often occur in the same ore deposits as lanthanides and also have some similar chemical properties. Rare earth elements are useful in a variety of applications in the electronics, defense, and medical industries, as well as in other applications. An oxide of a rare earth element is a “rare earth oxide” and can be used for analytical purposes or may be useful as a component of ceramics, catalysts, and/or coatings, among other uses. It is to be understood that when referencing rare earth elements that any of the elements can be present in a zero valence or elemental state, or in an ionized or valence state associated in the art with the individual element, and all forms are understood to be collectively included within the meaning of “rare earth elements”. Moreover, it is to be understood that reference to any individual rare earth element, i.e., any one of lanthanum, cerium, praseodymium, neodymium, promethium, samarium, europium, gadolinium, terbium, dysprosium, holmium, erbium, thulium, ytterbium, lutetium, including scandium and yttrium, can be present in a zero valence or elemental state, or in an ionized or valence state associated in the art with the given element, and all forms are understood to be collectively included within the meaning of reference to said element. For example, reference to “lanthanum”, “an element such as lanthanum”, “a composition comprising lanthanum”, and the like, it is understood that the reference inclusive any or all forms of lanthanum such as La⁰, La⁺¹, La⁺², and La⁺³. It is further understood that a reference to any given rare earth element is inclusive of all isotopic forms of the element.

As used herein, the terms “heavy rare earth elements” and “HREE” can be used interchangeably and refer to yttrium, gadolinium, terbium, dysprosium, holmium, erbium, thulium, ytterbium, and lutetium. It is to be understood that yttrium can be classified as a heavy rare earth element due to chemical properties and co-location with other HREEs in ores, but can also be yttrium is classified as a light rare earth element due to its lower atomic weight.

As used herein, the terms “light rare earth elements” and “LREE” can be used interchangeably and refer to scandium, lanthanum, cerium, praseodymium, neodymium, promethium, samarium, and europium. In some aspects, these designations may differ slightly but are generally based on atomic weight.

As used herein, the term “total rare earth elements” and “TREE” can be used interchangeably and refer the total REE present in a disclosed composition or product of a disclosed process, method, or device, wherein the REE comprises

“Critical minerals” (CM) as used herein include minerals important to national security and the economy. REEs are considered critical minerals due to their numerous industrial uses. Other critical minerals may also be purified and concentrated using the disclosed process including, but not limited to, cobalt, gallium, germanium, hafnium, indium, niobium, rhenium, rubidium, tantalum, and tellurium.

As used herein, “gangue” metals and other materials are undesired materials that surround or are co-located with the REEs being isolated and concentrated by the disclosed process. In one aspect, in the present process, gangue material can include, but is not limited to, aluminum, calcium, magnesium, manganese, silicon, chloride, and the like. In some aspects, gangue materials may have little or no economic value. In other aspects, gangue materials may have industrial uses but their presence alongside more valuable REEs can complicate the recovery of the REEs.

“Acid mine drainage” (AMD) as used herein refers to acidic water that outflows from mines such as, for example, metal mines or coal mines. In one aspect, AMD intensifies in scale and scope when construction, mining, and other activities that disturb the earth occur in and around rocks containing sulfide minerals. AMD can have high concentrations of metal ions that can cause detrimental effects to aquatic environments, especially in combination with low pH. AMD from coal mines and other sources often contains trace amounts of REEs, as well. “Acid mine drainage” as understood within the definition herein can be aqueous effluent from mining operations, mill tailings, overburden from mining operations, excavations, acid process waste streams, seepages, and other aqueous flows having elevated levels of metal ions and/or anions. Acid mine drainage is characterized by the presence of metals such as iron, manganese, aluminum, cadmium, cobalt, copper, lead, magnesium, molybdenum, nickel, zinc, and others. Acid mine drainage may also include undesirable anions such as sulfate, fluoride, nitrate and chloride. As used in the present application, “mine” is understood to mean active, inactive or abandoned mining operations for removing minerals, metals, ores or coal from the earth. Environmental regulations promulgated by the Environmental Protection Agency under CAA, RCRA, and CERCLA, as well as those promulgated by state and local authorities, mandate that the concentration of certain minerals and metals in specific aqueous effluents be less than the established regulatory levels.

“AMD precipitate” (AMDp) as used herein refers to a byproduct of AMD treatment. In one aspect, AMDp contains REEs but may also contain gangue metals such as, for example, iron and aluminum. In one aspect, AMDp contains from about 0.06% to about 0.1% REE. As used herein, “enriched AMD precipitate” (eAMDp) refers to an AMD product having from about 0.1% to about 5% REE on a dry weight basis. In another aspect, eAMDp has a lower gangue metal content then AMDp.

A “feedstock” as used herein is a raw material processed to recover REEs and other valuable components (e.g., CMs). A feedstock may be too toxic to release into the natural environment and, in one aspect, the disclosed process can remove commercially valuable components from the feedstock while simultaneously rendering the feedstock suitable for environmental release.

As used herein, “pregnant leach solution” (PLS) is water with an acidic pH and a high metal content. In one aspect, PLS can be processed using several purification technologies including, but not limited to, solvent extraction, ion exchange resins, selective precipitation, and fractional crystallization to remove and/or concentrate the metals. In some aspects, PLS may have a high solids content and may require filtration prior to further processing.

“Raffinate,” meanwhile, refers to a product of chemical separation, wherein one or more components have been removed. In one aspect, following solvent extraction as disclosed herein, raffinate is the aqueous component depleted in REE content. In another aspect, raffinate can include undesired gangue material.

As used herein, “GEOTUBER” refers to a dewatering device made from a polypropylene fabric that can be produced according to the needs of a particular project or industry. In one aspect, sludge or other material to be separated is pumped into a GEOTUBE® container and a fabric liner keeps solids trapped inside while filtrate water escapes and can be directed to a treatment facility.

As used herein, “contacting” refers to the act of touching, making contact, or of bringing substances into immediate proximity.

As used herein, “decanting” or “decantation” includes pouring off a fluid, leaving a sediment or precipitate, thereby separating the fluid from the sediment or precipitate. The sediment or precipitate can be present as a slag.

As used herein, “filtering” or “filtration” refers to a mechanical method to separate solids from liquids by passing the feed stream through a porous sheet such as a ceramic or metal membrane, which retains the solids and allows the liquid to pass through. This can be accomplished by gravity, pressure or vacuum (suction). The filtering effectively separates the sediment and/or precipitate from the liquid.

Unless otherwise specified, temperatures referred to herein are based on atmospheric pressure (i.e., one atmosphere).

### Acronyms.

The following acronyms as follows are used herein throughout. It is understood that the fully written phrase or textual description can be used interchangeably with the acronym without changing the intended meaning.

| ACRONYM | BRIEF DESCRIPTION |
|---|---|
| AL | Acid Leaching |
| ALSX | Acid Leaching/Solvent Extraction |
| AMD | Raw Acid Mine Drainage |
| AMDp | Precipitate formed from AMD |
| CM | Critical Minerals |
| HPC | Hydraulic Pre-Concentrate |
| HREE | Heavy Rare Earth Element |
| HREO | Heavy Rare Earth Oxide |
| ICP-MS | Inductively Coupled Plasma Mass Spectrometry |
| ICP-OES | Inductively Coupled Plasma Optical Emission Spectrometry |
| LREE | Light Rare Earth Elements |
| LREO | Light Rare Earth Oxide |
| MREO | Mixed Rare Earth Oxide |
| NPDES | National Pollution Discharge Elimination System |
| OA | Oxalic Acid |
| PC | Pre-Concentrate |
| PLS | Pregnant Leach Solution |
| PVDF | Polyvinylidene fluoride |
| RE or REE | Rare Earth or Rare Earth Element |
| REE/CM | Rare Earth Element/Critical Mineral |
| REEF | Rare Earth Extraction Facility |
| SX | Solvent Extraction |
| WVU | West Virginia University |
| WVDEP | West Virginia Department of Environmental Protection |

### B. AMD AND PREPARATION OF REE/CM PRE-CONCENTRATE

REE/CMs are typically obtained from ore deposits. However, there are several issues associated with reliance on ore deposits as source material for REE/CMs, including, but not limited to, national security concerns around sourcing from essentially one country and the large volumes of potentially toxic waste associated with production of REE/CMs from mineral ores. There is an attractive alternative to mineral ores as a primary source for REE/CMs, namely acid mine drainage from operating and closed mines such as coal mines and hard rock mining operations. Acid mine drainage is a byproduct of the foregoing mining operations that is enriched in many REE/CMs, and as such, offers an opportunity for their preparation from readily available materials.

In various aspects, an AMD can be treated prior to discharge into the environment, e.g., mixing the AMD with lime to precipitate metals and to raise the pH. After settling and filtration, the treated water can normally be discharged to the environment. Generally, the conventional methods of treating AMD prior to discharge can be modified to provide a useful pre-concentrate that can serve as a feedstock for the disclosed methods of preparing a pregnant leach solution. For example, in a first step, the AMD can be titrated with lime (calcium oxide) to pH 4.0-4.5 to precipitate aluminum and iron. Following removal by settling or filtration of the precipitated materials, the clarified water can then be titrated to pH 8.5 with lime. At this pH, the REE/CMs precipitate as hydroxides along with other metals. The precipitate can be collected by use of settling systems or filtration, then dried or partially dried to form the pre-concentrate. The pre-concentrate thus obtained can be shipped for further processing and recovery of REE/CMs.

Various methods for preparation of REE/CM pre-concentrate materials from AMD have recently been described, including those disclosed in U.S. patents application Ser. Nos. 16/795,471, 17/115,128, and 17/706,584, as well as Intl. Pat. Appl. No. PCT/US2020/042674, each of which is incorporated herein by reference, particularly with reference to the methods of preparing REE/CM pre-concentrate materials from AMD (collectively referred to herein as “WVU REE/CM pre-concentrate processes”). The foregoing methods provide facile and high yield methods for increasing the concentration of REE/CMs compared to the original source AMD, removing gangue and other undesirable minerals or materials from the AMD, and providing a final product, a REE/CM pre-concentrate material, that is a useful feedstock for further enrichment and purification of REE/CMs.

In a further aspect, a pre-concentrate used in the disclosed methods for preparation of a pregnant leach solution is a pre-concentrate obtained from one or more of the WVU REE/CM pre-concentrate processes. In a still further aspect, the pre-concentrate obtained from the one or more of the WVU REE/CM pre-concentrate processes is a pre-concentrate solution such as a slurry pre-concentrate, hydraulic pre-concentrate, liquid pre-concentrate, or other semi-solid pre-concentrate mixture comprising liquid and REE/CMs suspended or dissolved in the liquid phase.

In a further aspect, a pre-concentrate used in the disclosed methods for preparation of a pregnant leach solution is a pre-concentrate obtained from one or more processes known to the skilled artisan. In a still further aspect, the pre-concentrate obtained from one or more of the one or more processes known to the skilled artisan is a pre-concentrate solution such as a slurry pre-concentrate, hydraulic pre-concentrate, liquid pre-concentrate, or other semi-solid pre-concentrate mixture comprising liquid and REE/CMs suspended or dissolved in the liquid phase.

In a further aspect, a pre-concentrate—prepared by any of the foregoing referenced processes—that is a pre-concentrate solution such as a slurry pre-concentrate, hydraulic pre-concentrate, liquid pre-concentrate, or other semi-solid pre-concentrate mixture comprising liquid and REE/CMs suspended or dissolved in the liquid phase can be further treated to obtain a dried or essentially dry pre-concentrate. For example, a slurry, hydraulic pre-concentrate, liquid concentrate, or other mixture comprising liquid and REE/CMs suspended or dissolved in the liquid phase can be heated, dried by passive evaporation (e.g., in evaporative ponds or tanks), or a significant proportion of liquid removed using geobags. In drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is about 50%, about 55%, about 60%, about 65%, about 70%, about 75%, about 80%, about 85%, about 90%, about 95%, about 97%, about 98%, about 99%, about 100%; or a range encompassing as a lower and upper end any two of the foregoing value; or any combination of discrete values from the foregoing values. In a still further aspect, drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is from about 90% to about 100%. In a yet further aspect, drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is from about 95% to about 100%. In an even further aspect, drying the slurry pre-concentrate, hydraulic pre-concentrate, liquid pre-concentrate, or other semi-solid pre-concentrate mixture, the drying can remove a percentage of the initial liquid phase from the pre-concentrate, wherein the percentage removed, by weight or volume, is from about 98% to about 100%.

In various aspects, a pre-concentrate that is a slurry pre-concentrate, hydraulic pre-concentrate, liquid pre-concentrate, or other semi-solid pre-concentrate mixture has a solids concentration of from about 0.05% solids to about 5% solids; from about 0.1% solids to about 4.5% solids; from about 0.1% solids to about 4.0% solids; from about 0.1% solids to about 3.5% solids; from about 0.1% solids to about 3.0% solids; from about 0.1% solids to about 2.5% solids; from about 0.1% solids to about 2.0% solids; from about 0.1% solids to about 1.5% solids; from about 0.1% solids to about 1.0% solids; from about 0.1% solids to about 0.7% solids; or from about 0.1% solids to about 0.5% solids.

In a further aspect, a pre-concentrate that is a slurry pre-concentrate, hydraulic pre-concentrate, liquid pre-concentrate, or other semi-solid pre-concentrate mixture has a solids concentration of from about 0.1% solids to about 10% solids; from about 0.2% solids to about 9% solids; from about 0.2% solids to about 9% solids; from about 0.2% solids to about 7.5% solids; from about 0.2% solids to about 6% solids; from about 0.2% solids to about 5% solids; from about 0.2% solids to about 4% solids; from about 0.2% solids to about 3% solids; from about 0.2% solids to about 2% solids; from about 0.2% solids to about 1.5% solids; or from about 0.2% solids to about 1% solids.

In a further aspect, a pre-concentrate that is a slurry pre-concentrate, hydraulic pre-concentrate, liquid pre-concentrate, or other semi-solid pre-concentrate mixture has a solids concentration of from about 1% solids to about 10% solids; from about 1% solids to about 9% solids; from about 1% solids to about 9% solids; from about 1% solids to about 7.5% solids; from about 1% solids to about 6% solids; from about 1% solids to about 5% solids; from about 1% solids to about 4% solids; from about 1% solids to about 3% solids; from about 1% solids to about 2% solids; or from about 1% solids to about 1.5% solids.

In a further aspect, a pre-concentrate that is a slurry pre-concentrate, hydraulic pre-concentrate, liquid pre-concentrate, or other semi-solid pre-concentrate mixture has a solids concentration of from about 2% solids to about 10% solids; from about 2% solids to about 9% solids; from about 2% solids to about 9% solids; from about 2% solids to about 7.5% solids; from about 2% solids to about 6% solids; from about 2% solids to about 5% solids; from about 2% solids to about 4% solids; or from about 2% solids to about 3% solids.

In a further aspect, a pre-concentrate that is a slurry pre-concentrate, hydraulic pre-concentrate, liquid pre-concentrate, or other semi-solid pre-concentrate mixture has a solids concentration of from about 3% solids to about 10% solids; from about 3% solids to about 9% solids; from about 3% solids to about 9% solids; from about 3% solids to about 7.5% solids; from about 3% solids to about 6% solids; from about 3% solids to about 5% solids; or from about 3% solids to about 4% solids.

In a further aspect, a pre-concentrate that is a slurry pre-concentrate, hydraulic pre-concentrate, liquid pre-concentrate, or other semi-solid pre-concentrate mixture has a solids concentration of from about 4% solids to about 10% solids; from about 4% solids to about 9% solids; from about 4% solids to about 9% solids; from about 4% solids to about 7.5% solids; from about 4% solids to about 6% solids; or from about 4% solids to about 5% solids.

In various aspects, a pre-concentrate that is a slurry pre-concentrate, hydraulic pre-concentrate, liquid pre-concentrate, or other semi-solid pre-concentrate mixture comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 5 mg/L to about 500 mg/L.

In a further aspect, a pre-concentrate that is a slurry pre-concentrate, hydraulic pre-concentrate, liquid pre-concentrate, or other semi-solid pre-concentrate mixture comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 50 mg/L to about 500 mg/L.

In a further aspect, a pre-concentrate that is a slurry pre-concentrate, hydraulic pre-concentrate, liquid pre-concentrate, or other semi-solid pre-concentrate mixture comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 100 mg/L to about 500 mg/L.

In various aspects, a pre-concentrate that is a slurry pre-concentrate, hydraulic pre-concentrate, liquid pre-concentrate, or other semi-solid pre-concentrate mixture comprises scandium at a concentration of from about 0.01 mg/L to about 0.5 mg/L; yttrium at a concentration of from about 1.0 mg/L to about 200 mg/L; lanthanum at a concentration of from about 0.01 mg/L to about 5 mg/L; cerium at a concentration of from about 0.5 mg/L to about 70 mg/L; praseodymium at a concentration of from about 0.1 mg/L to about 15 mg/L; neodymium at a concentration of from about 0.5 mg/L to about 80 mg/L; samarium at a concentration of from about 0.2 mg/L to about 30 mg/L; europium at a concentration of from about 0.05 mg/L to about 10 mg/L; gadolinium at a concentration of from about 0.2 mg/L to about 50 mg/L; terbium at a concentration of from about 0.05 mg/L to about 10 mg/L; dysprosium at a concentration of from about 0.2 mg/L to about 50 mg/L; holmium at a concentration of from about 0.05 mg/L to about 10 mg/L; erbium at a concentration of from about 0.1 mg/L to about 30 mg/L; thulium at a concentration of from about 0.01 mg/L to about 3 mg/L; ytterbium at a concentration of from about 0.05 mg/L to about 10 mg/L; and lutetium at a concentration of from about 0.01 mg/L to about 1 mg/L.

In various aspects, a pre-concentrate that is a slurry pre-concentrate, hydraulic pre-concentrate, liquid pre-concentrate, or other semi-solid pre-concentrate mixture comprises scandium at a concentration of from about 0.05 mg/L to about 0.15 mg/L; yttrium at a concentration of from about 20 mg/L to about 45 mg/L; lanthanum at a concentration of from about 0.3 mg/L to about 0.75 mg/L; cerium at a concentration of from about 5 mg/L to about 15 mg/L; praseodymium at a concentration of from about 1 mg/L to about 3.5 mg/L; neodymium at a concentration of from about 5 mg/L to about 20 mg/L; samarium at a concentration of from about 2 mg/L to about 7 mg/L; europium at a concentration of from about 0.5 mg/L to about 2 mg/L; gadolinium at a concentration of from about 5 mg/L to about 15 mg/L; terbium at a concentration of from about 0.5 mg/L to about 2 mg/L; dysprosium at a concentration of from about 4 mg/L to about 15 mg/L; holmium at a concentration of from about 0.5 mg/L to about 3 mg/L; erbium at a concentration of from about 2.5 mg/L to about 6 mg/L; thulium at a concentration of from about 0.2 mg/L to about 0.7 mg/L; ytterbium at a concentration of from about 0.7 mg/L to about 2.5 mg/L; and lutetium at a concentration of from about 0.05 mg/L to about 0.3 mg/L.

In various aspects, a precontrate used in the disclosed methods is a solid pre-concentrate material preparation comprising a pre-concentrate. The solid pre-concentrate material preparation can be a powder, an amorphous solid, a particulate, a block, or other solid form that is dry or substantially dry. If a solid pre-concentrate material preparation is used as a feedstock for a solvent extraction process for recovery of REE/CMs, the pre-concentrate can be dissolved in a mineral acid solution. The resulting solution contains high concentrations of silicate. Table 1 shows representative concentrations obtained when 1 gram of solid pre-concentrate material preparation obtained as described above is extracted with 20 milliliters of 1 molar solutions of hydrochloric acid, nitric acid and sulfuric acid. While the acids dissolved 80-90% of the REEs present in the pre-concentrate, they also dissolved a large portion of the silicates. Silicate concentrations of 2,000 to 4,000 milligrams per liter can cause problems in the solvent extraction system or other desired processing steps. For example, the presence of silicates—particularly at or about the foregoing concentrations—can promote crud formation which can foul the solvent extraction units and reduce the efficiency of separating REEs from the other metals present.

TABLE 1
Concentrations of silicon and total rare earths (TREE)
in mg/L after acid extraction of a pre-concentrate.

| | Acid Treatment | | |
|---|---|---|---|
| Species | HCl | HNO₃ | H₂SO₄ |
| Silicates | 2040 | 2860 | 3960 |
| TREE | 577 | 526 | 531 |

In various aspects, a solid pre-concentrate material preparation comprises a TREE concentration that is about 1000 mg TREE to about 50000 mg TREE per kg of solid pre-concentrate material. In a further aspect, a solid pre-concentrate material preparation comprises a TREE concentration that is about 2500 mg TREE to about 50000 mg TREE per kg of solid pre-concentrate material. In a still further aspect, a solid pre-concentrate material preparation comprises a TREE concentration that is about 3000 mg TREE to about 50000 mg TREE per kg of solid pre-concentrate material. In a yet further aspect, a solid pre-concentrate material preparation comprises a TREE concentration that is about 4000 mg TREE to about 50000 mg TREE per kg of solid pre-concentrate material. In an even further aspect, a solid pre-concentrate material preparation comprises a TREE concentration that is about 5000 mg TREE to about 50000 mg TREE per kg of solid pre-concentrate material. In a still further aspect, a solid pre-concentrate material preparation comprises a TREE concentration that is about 7500 mg TREE to about 50000 mg TREE per kg of solid pre-concentrate material. In a yet further aspect, a solid pre-concentrate material preparation comprises a TREE concentration that is about 10000 mg TREE to about 50000 mg TREE per kg of solid pre-concentrate material. In an even further aspect, a solid pre-concentrate material preparation comprises a TREE concentration that is about 20000 mg TREE to about 50000 mg TREE per kg of solid pre-concentrate material.

In various aspects, a solid pre-concentrate material preparation comprises a TREE concentration that is about 1000 mg TREE to about 40000 mg TREE per kg of solid pre-concentrate material. In a further aspect, a solid pre-concentrate material preparation comprises a TREE concentration that is about 1000 mg TREE to about 35000 mg TREE per kg of solid pre-concentrate material. In a yet further aspect, a solid pre-concentrate material preparation comprises a TREE concentration that is about 1000 mg TREE to about 30000 mg TREE per kg of solid pre-concentrate material. In an even further aspect, a solid pre-concentrate material preparation comprises a TREE concentration that is about 1000 mg TREE to about 25000 mg TREE per kg of solid pre-concentrate material. In a still further aspect, a solid pre-concentrate material preparation comprises a TREE concentration that is about 1000 mg TREE to about 20000 mg TREE per kg of solid pre-concentrate material. In a yet further aspect, a solid pre-concentrate material preparation comprises a TREE concentration that is about 1000 mg TREE to about 15000 mg TREE per kg of solid pre-concentrate material. In an even further aspect, a solid pre-concentrate material preparation comprises a TREE concentration that is about 1000 mg TREE to about 10000 mg TREE per kg of solid pre-concentrate material.

### C. DISCLOSED METHODS FOR PREPARATION OF PREGNANT LEACH SOLUTION FROM REE/CM PRE-CONCENTRATE

In one aspect, the disclosure relates to a method for preparation of pregnant leach solution from an AMD REE/CM pre-concentrate. As discussed herein above, the pre-concentrate is a pre-concentrate solution or solid pre-concentrate material preparation derived from acid mine drainage from mines such as coal mines and hard rock mining operations. The pre-concentrate is enriched in REE/CMs compared to the amounts and concentrations in the acid mine drainage material, while at the same time has had the amounts and concentrations of undesirable components, e.g., gangue metals and silicates, decreased relative to the acid mine drainage material. The disclosed methods for the preparation of pregnant leach solution from an AMD REE/CM pre-concentrate provides for further separation and recovery of the desired REE/CM components while at the same time minimizing the extraction of silicates from pre-concentrate.

In a further aspect, the pre-concentrate, e.g., a solid pre-concentrate material preparation as described herein, is mixed with a mineral acid in a controlled mass ratio thereby forming an acid leached solution. In a yet further aspect, the mineral acid can be hydrochloric acid, sulfuric acid, nitric acid, and the like, or combinations thereof. In a still further aspect, the mineral acid is hydrochloric acid. In a yet further aspect, the mineral acid is hydrochloric acid. In an even further aspect, the mineral acid is a mixture of sulfuric acid and hydrochloric acid.

In a further aspect, the mineral acid, in various aspects, can be a concentrated mineral acid. For example, if hydrochloric acid is used, then it may be desirable that it is the hydrochloric acid is about 12 M (36-38 wt %) in water. In a further aspect, the hydrochloric acid is greater than or equal to about 6 M, about 7 M, about 8 M, about 9 M, about 10 M, about 11 M, about 12 M, or a range encompassed by any of the foregoing values, or a combination of the foregoing values. In an even further aspect, the hydrochloric acid is greater than or equal to about 10 M. In a still further aspect, the hydrochloric acid is greater than or equal to about 12 M. In an even further aspect, the hydrochloric acid is from about 9 M to about 12 M. In a still further aspect, the hydrochloric acid is from about 9.5 M to about 12 M. In a still further aspect, the hydrochloric acid is from about 10 M to about 12 M.

In a further aspect, the controlled mass ratio of mineral acid to pre-concentrate is about 0.5 g pre-concentrate to 1 mL mineral acid (denoted herein following as 1 mL Acid: g PC). In a still further aspect, the controlled mass ratio of pre-concentrate to volume of mineral acid is about 1 mL Acid: 0.05 g PC, about 1 mL Acid: 0.06 g PC, about 1 mL Acid: 0.07 g PC, about 1 mL Acid: 0.08 g PC, about 1 mL Acid: 0.09 g PC, about 1 mL Acid: 0.1 g PC, about 1 mL Acid: 0.2 g PC, about 1 mL Acid: 0.3 g PC, about 1 mL Acid: 0.4 g PC, about 1 mL Acid: 0.5 g PC, about 1 mL Acid: 0.6 g PC, about 1 mL Acid: 0.7 g PC, about 1 mL Acid: 0.8 g PC, about 1 mL Acid: 0.9 g PC, about 1 mL Acid: 1 g PC, or a range encompassed by any of the foregoing values, or a combination of the foregoing values. In a yet further aspect, the controlled mass ratio of mineral acid to pre-concentrate is from about 1 mL Acid: 0.3 g PC to about 1 mL Acid: 0.7 g PC. In a yet further aspect, the controlled mass ratio of mineral acid to pre-concentrate is from about 1 mL Acid: 0.4 g PC to about 1 mL Acid: 0.6 g PC. The amount can be varied to from the foregoing and is generally added in an amount sufficient to effect precipitation of silicates and polymerized silicates.

In a further aspect, following addition of the controlled mass ratio of mineral acid, the acid leached solution, e.g., a slurry of the mineral acid and the pre-concentrate, is optionally heated at a suitable temperature for a suitable period of time thereby forming a heat-treated acid leached solution. It is believed that heating facilitates removal of excess mineral acid.

In a further aspect, the acid leached solution is heated at a suitable temperature that is about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., or a range encompassing the foregoing values, or a group or set of the foregoing values. In a yet further aspect, the pre-concentrate-acid mixture is heated at from about 65° C. to about 95° C. In an even further aspect, the pre-concentrate-acid mixture is heated at from about 70° C. to about 90° C. In a still further aspect, the pre-concentrate-acid mixture is heated at from about 75° C. to about 85° C. In a yet further aspect, the pre-concentrate-acid mixture is heated at from about 65° C. to about 150° C. In an even further aspect, the pre-concentrate-acid mixture is heated at from about 70° C. to about 150° C. In a still further aspect, the pre-concentrate-acid mixture is heated at from about 75° C. to about 150° C. In a yet further aspect, the pre-concentrate-acid mixture is heated at from about 65° C. to about 120° C. In an even further aspect, the pre-concentrate-acid mixture is heated at from about 70° C. to about 120° C. In a still further aspect, the pre-concentrate-acid mixture is heated at from about 75° C. to about 120° C.

In a further aspect, the pre-concentrate-acid mixture is heated for a suitable period of time that is about 15 minutes, about 20 minutes, about 25 minutes, about 30 minutes, about 35 minutes, about 40 minutes, about 45 minutes, about 60 minutes, about 90 minutes, about 120 minutes, about 150 minutes, about 180 minutes, or a range encompassing the foregoing values, or a group or set of the foregoing values. In a yet further aspect, the pre-concentrate-acid mixture is heated for a period of time that is from about 15 minutes to about 120 minutes. In a still further aspect, the pre-concentrate-acid mixture is heated for a period of time that is from about 30 minutes to about 90 minutes.

In a further aspect, the acid leached solution or the heat-treated acid leached solution can be dried, e.g., using a suitable drying apparatus such as screw dryer, evaporative dryer, or other drying apparatus as know to one skilled in the art, thereby forming a dried acid leached material.

In a further aspect, the acid leached solution or the heat-treated acid leached solution is further diluted with water thereby forming a water leached solution. Alternatively, the dried acid leached material can be used and mixed with water to form a water leached solution. In a still further aspect, the water is added to the pre-concentrate-acid mixture, the heat-treated pre-concentrate-acid mixture, or dried acid leached material in a controlled mass ratio of pre-concentrate to volume of water, thereby forming a water leached solution. For example, water can be added in a ratio of g pre-concentrate to mL water (denoted herein following as mL water: g PC). In a still further aspect, the controlled mass ratio of pre-concentrate to mineral acid is about 1 mL water: 0.05 g PC, about 1 mL water: 0.06 g PC, about 1 mL water: 0.07 g PC, about 1 mL water: 0.08 g PC, about 1 mL water: 0.09 g PC, about 1 mL water: 0.1 g PC, about 1 mL water: 0.2 g PC, about 1 mL water: 0.3 g PC, about 1 mL water: 0.4 g PC, about 1 ml water: 0.5 g PC, or a range encompassed by any of the foregoing values, or a combination of the foregoing values. In a yet further aspect, the controlled mass ratio of mineral acid to pre-concentrate is from about 1 mL water: 0.01 g PC to about 1 mL water: 0.2 g PC. In a yet further aspect, the controlled mass ratio of mineral acid to pre-concentrate is from about 1 ml water: 0.05 g PC to about 1 mL water: 0.15 g PC.

In a further aspect, the solids and liquid in the water leached solution are separated from one another, and the liquid retained to be used in the next step described below. Suitable methods for separating solids and liquid in the water leached solution include one or more of solid-liquid seperators recognized by the skilled artisan, including, but not limited to, sedimentation, filtration (including ultrafiltration or microfiltration), centrifugation (including use of a solid-bowl decanter), and the like. In a yet further aspect, a combination of the foregoing can be used sequentially, e.g., the water leached solution can be subjected to centrifugation followed by filtration.

In a further aspect, the water leached solution, the acid leached solution or the heat-treated acid leached solution is treated with a base thereby forming a pre-neutralization solution. In a still further aspect, the base can be a basic solution, e.g., an aqueous solution comprising a base in which the base can be a weak base or a strong base, or alternatively the base can be a solid, e.g., a powder, granules, chips, and the like. In various aspects, the base can be selected from ammonium carbonate, ammonia or ammonium hydroxide, anhydrous sodium carbonate (Na₂CO₃, soda ash), hydrated sodium carbonate (Na₂CO₃·nH₂O, washing soda), sodium bicarbonate (NaHCO₃, baking soda), sodium hydroxide (NaOH, caustic soda), anhydrous potassium carbonate (K₂CO₃), hydrated potassium carbonate (K₂CO₃·nH₂O), potassium bicarbonate (KHCO₃), potassium hydroxide (KOH), calcium oxide (CaO, lime, quicklime, or burnt lime), calcium hydroxide (Ca(OH)₂, hydrated lime or slaked lime), and combinations thereof.

In a further aspect, the amount of the base added to the the water leached solution, the acid leached solution or the heat-treated acid leached solution is an amount sufficient to effect precipitation of residual aluminum and/or iron while at the same time occurring without significant precipitation of REE/CMs, e.g., less than about 10% concomitant co-precipitation of REE/CMs. In a still further aspect, the amount of the base added to the the water leached solution is sufficient to change the pH to a pH of from about 3.5 to about 7.5. In a yet further aspect, the amount of the base added to the the water leached solution is sufficient to change the pH to a pH of from about 4.0 to about 7.0. In an even further aspect, the amount of the base added to the the water leached solution is sufficient to change the pH to a pH of from about 4.5 to about 7.0. In a still further aspect, the amount of the base added to the the water leached solution is sufficient to change the pH to a pH of from about 5.0 to about 7.0. In a yet further aspect, the amount of the base added to the the water leached solution is sufficient to change the pH to a pH of from about 5.5 to about 7.0. In an even further aspect, the amount of the base added to the the water leached solution is sufficient to change the pH to a pH of from about 6.0 to about 7.0. In a still further aspect, the amount of the base added to the the water leached solution is sufficient to change the pH to a pH of from about 4.0 to about 6.5. In a yet further aspect, the amount of the base added to the the water leached solution is sufficient to change the pH to a pH of from about 4.0 to about 6.0. In an even further aspect, the amount of the base added to the the water leached solution is sufficient to change the pH to a pH of from about 4.0 to about 5.5. In a still further aspect, the amount of the base added to the the water leached solution is sufficient to change the pH to a pH of from about 4.0 to about 5.0.

In a further aspect, the solids and liquid in the pre-neutralization solution are optionally separated from one another, and the liquid retained for use in the next step described below. The solids and liquid in the pre-neutralization solution can be separated by use of one or more of solid-liquid seperators recognized by the skilled artisan, as described above, including, but not limited to, sedimentation, filtration (including ultrafiltration or microfiltration), centrifugation (including use of a solid-bowl decanter), and the like. In a yet further aspect, filtration can be used to separate solids and liquid in the pre-neutralization solution.

In a further aspect, the liquid retained from separation of the solids and liquid in the pre-neutralization solution is treated with a base to further increase the pH of the solution, thereby forming a neutralization solution. The pH can be raised to a pH value such that the pregnant leach solution is for further processing such as further processing by solvent extraction methods, e.g., a pH from about 3.5 to about 7.5 or a pH from about 4.0 to about 7.0. In a still further aspect, the amount of the base added to the the water leached solution is sufficient to change the pH to a pH of from about 3.5 to about 7.5. In a yet further aspect, the amount of the base added to the the water leached solution is sufficient to change the pH to a pH of from about 4.0 to about 7.0. In an even further aspect, the amount of the base added to the the water leached solution is sufficient to change the pH to a pH of from about 4.5 to about 7.0. In a still further aspect, the amount of the base added to the the water leached solution is sufficient to change the pH to a pH of from about 5.0 to about 7.0. In a yet further aspect, the amount of the base added to the the water leached solution is sufficient to change the pH to a pH of from about 5.5 to about 7.0. In an even further aspect, the amount of the base added to the the water leached solution is sufficient to change the pH to a pH of from about 6.0 to about 7.0. In a still further aspect, the amount of the base added to the the water leached solution is sufficient to change the pH to a pH of from about 4.0 to about 6.5. In a yet further aspect, the amount of the base added to the the water leached solution is sufficient to change the pH to a pH of from about 4.0 to about 6.0. In an even further aspect, the amount of the base added to the the water leached solution is sufficient to change the pH to a pH of from about 4.0 to about 5.5. In a still further aspect, the amount of the base added to the the water leached solution is sufficient to change the pH to a pH of from about 4.0 to about 5.0.

The base used to treat the liquid retained from separation of the solids and liquid in the pre-neutralization solution can be a base as discussed herein above. That is, the base can be a basic solution, e.g., an aqueous solution comprising a base in which the base can be a weak base or a strong base, or alternatively a base can be a solid, e.g., a powder, granules, chips, and the like. In various aspects, the base used in this step can be selected from ammonium carbonate, ammonia or ammonium hydroxide, anhydrous sodium carbonate (Na₂CO₃, soda ash), hydrated sodium carbonate (Na₂CO₃·nH₂O, washing soda), sodium bicarbonate (NaHCO₃, baking soda), sodium hydroxide (NaOH, caustic soda), anhydrous potassium carbonate (K₂CO₃), hydrated potassium carbonate (K₂CO₃·nH₂O), potassium bicarbonate (KHCO₃), potassium hydroxide (KOH), calcium oxide (CaO, lime, quicklime, or burnt lime), or calcium hydroxide (Ca(OH)₂, hydrated lime or slaked lime), and combinations thereof. In a further aspect, the amount of the base added to the liquid retained from separation of the solids and liquid in the pre-neutralization solution is an amount sufficient to obtain a pH suitable for the disclosed pregnant leach solution as needed or required for further downstream processing.

In a further aspect, the amount of base used in this step, i.e., the amount of base used to treat the pre-neutralization solution and forming a neutralization solution is an amount sufficient to recover or retain from about 0 wt % to about 100 wt % of gangue metals, such as Si, Al, and/or Fe, on the total amount of gangue in the initial acid leached solution; and from about 50 wt % to about 100 wt % of the REE/CMs based the total REE/CMs in the initial acid leached solution.

In a further aspect, the amount of base used to treat the pre-neutralization solution is an amount sufficient to recover or retain from about 0 wt % to about 20 wt % of gangue metals, such as Si, Al, and/or Fe, on the total amount of gangue in the initial acid leached solution; and from about 50 wt % to about 100 wt % of the REE/CMs based the total REE/CMs in the initial acid leached solution. In a still further aspect, the amount of base used to treat the pre-neutralization solution is an amount sufficient to recover or retain from about 0 wt % to about 10 wt % of gangue metals, such as Si, Al, and/or Fe, on the total amount of gangue in the initial acid leached solution; and from about 50 wt % to about 100 wt % of the REE/CMs based the total REE/CMs in the initial acid leached solution. In a yet further aspect, the amount of base used to treat the pre-neutralization solution is an amount sufficient to recover or retain from about 0 wt % to about 7.5 wt % of gangue metals, such as Si, Al, and/or Fe, on the total amount of gangue in the initial acid leached solution; and from about 50 wt % to about 100 wt % of the REE/CMs based the total REE/CMs in the initial acid leached solution. In an even further aspect, the amount of base used to treat the pre-neutralization solution is an amount sufficient to recover or retain from about 0 wt % to about 5 wt % of gangue metals, such as Si, Al, and/or Fe, on the total amount of gangue in the initial acid leached solution; and from about 50 wt % to about 100 wt % of the REE/CMs based the total REE/CMs in the initial acid leached solution.

In a further aspect, the amount of base used to treat the pre-neutralization solution is an amount sufficient to recover or retain from about 0 wt % to about 20 wt % of gangue metals, such as Si, Al, and/or Fe, on the total amount of gangue in the initial acid leached solution; and from about 60 wt % to about 100 wt % of the REE/CMs based the total REE/CMs in the initial acid leached solution. In a still further aspect, the amount of base used to treat the pre-neutralization solution is an amount sufficient to recover or retain from about 0 wt % to about 20 wt % of gangue metals, such as Si, Al, and/or Fe, on the total amount of gangue in the initial acid leached solution; and from about 70 wt % to about 100 wt % of the REE/CMs based the total REE/CMs in the initial acid leached solution. In a yet further aspect, the amount of base used to treat the pre-neutralization solution is an amount sufficient to recover or retain from about 0 wt % to about 20 wt % of gangue metals, such as Si, Al, and/or Fe, on the total amount of gangue in the initial acid leached solution; and from about 80 wt % to about 100 wt % of the REE/CMs based the total REE/CMs in the initial acid leached solution. In an even further aspect, the amount of base used to treat the pre-neutralization solution is an amount sufficient to recover or retain from about 0 wt % to about 20 wt % of gangue metals, such as Si, Al, and/or Fe, on the total amount of gangue in the initial acid leached solution; and from about 90 wt % to about 100 wt % of the REE/CMs based the total REE/CMs in the initial acid leached solution.

In a further aspect, the amount of base used to treat the pre-neutralization solution is an amount sufficient to recover or retain from about 0 wt % to about 10 wt % of gangue metals, such as Si, Al, and/or Fe, on the total amount of gangue in the initial acid leached solution; and from about 60 wt % to about 100 wt % of the REE/CMs based the total REE/CMs in the initial acid leached solution. In a still further aspect, the amount of base used to treat the pre-neutralization solution is an amount sufficient to recover or retain from about 0 wt % to about 10 wt % of gangue metals, such as Si, Al, and/or Fe, on the total amount of gangue in the initial acid leached solution; and from about 70 wt % to about 100 wt % of the REE/CMs based the total REE/CMs in the initial acid leached solution. In a yet further aspect, the amount of base used to treat the pre-neutralization solution is an amount sufficient to recover or retain from about 0 wt % to about 10 wt % of gangue metals, such as Si, Al, and/or Fe, on the total amount of gangue in the initial acid leached solution; and from about 80 wt % to about 100 wt % of the REE/CMs based the total REE/CMs in the initial acid leached solution. In an even further aspect, the amount of base used to treat the pre-neutralization solution is an amount sufficient to recover or retain from about 0 wt % to about 10 wt % of gangue metals, such as Si, Al, and/or Fe, on the total amount of gangue in the initial acid leached solution; and from about 90 wt % to about 100 wt % of the REE/CMs based the total REE/CMs in the initial acid leached solution.

In a further aspect, the amount of base used to treat the pre-neutralization solution is an amount sufficient to recover or retain from about 0 wt % to about 5 wt % of gangue metals, such as Si, Al, and/or Fe, on the total amount of gangue in the initial acid leached solution; and from about 60 wt % to about 100 wt % of the REE/CMs based the total REE/CMs in the initial acid leached solution. In a still further aspect, the amount of base used to treat the pre-neutralization solution is an amount sufficient to recover or retain from about 0 wt % to about 5 wt % of gangue metals, such as Si, Al, and/or Fe, on the total amount of gangue in the initial acid leached solution; and from about 70 wt % to about 100 wt % of the REE/CMs based the total REE/CMs in the initial acid leached solution. In a yet further aspect, the amount of base used to treat the pre-neutralization solution is an amount sufficient to recover or retain from about 0 wt % to about 5 wt % of gangue metals, such as Si, Al, and/or Fe, on the total amount of gangue in the initial acid leached solution; and from about 80 wt % to about 100 wt % of the REE/CMs based the total REE/CMs in the initial acid leached solution. In an even further aspect, the amount of base used to treat the pre-neutralization solution is an amount sufficient to recover or retain from about 0 wt % to about 5 wt % of gangue metals, such as Si, Al, and/or Fe, on the total amount of gangue in the initial acid leached solution; and from about 90 wt % to about 100 wt % of the REE/CMs based the total REE/CMs in the initial acid leached solution.

In various aspects, the pregnant leach solution obtained by the disclosed methods for preparation of a pregnant leach solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 5 mg/L to about 500 mg/L.

In a further aspect, the pregnant leach solution obtained by the disclosed methods for preparation of a pregnant leach solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 50 mg/L to about 500 mg/L.

In a further aspect, the pregnant leach solution obtained by the disclosed methods for preparation of a pregnant leach solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 100 mg/L to about 500 mg/L.

In a further aspect, the solids and liquid in the neutralization solution are optionally separated from one another, and the liquid retained forms the disclosed pregnant leach solution. The solids and liquid in the neutralization solution can be separated by use of one or more of solid-liquid seperators recognized by the skilled artisan, as described above, including, but not limited to, sedimentation, filtration (including ultrafiltration or microfiltration), centrifugation (including use of a solid-bowl decanter), and the like. In a yet further aspect, filtration can be used to separate solids and liquid in the neutralization solution.

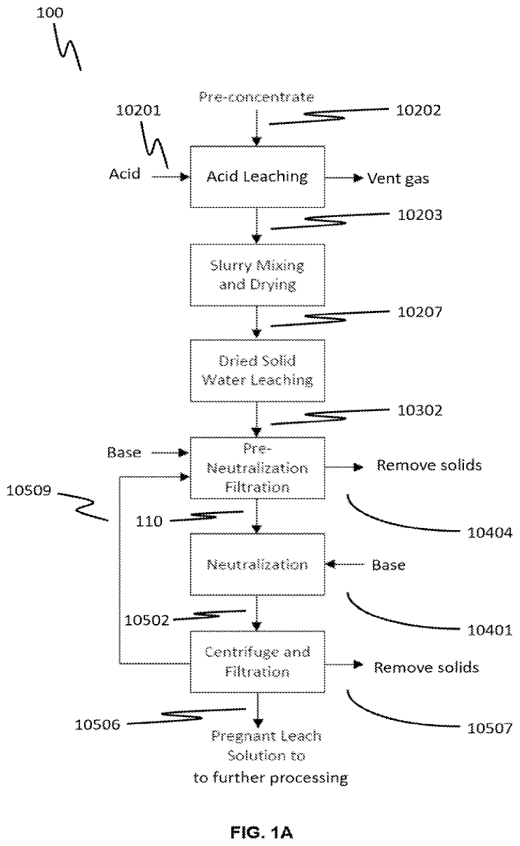

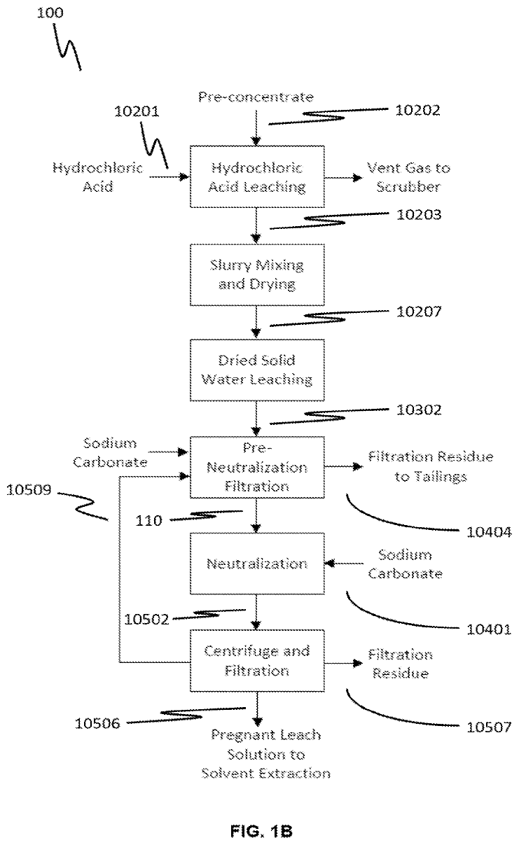

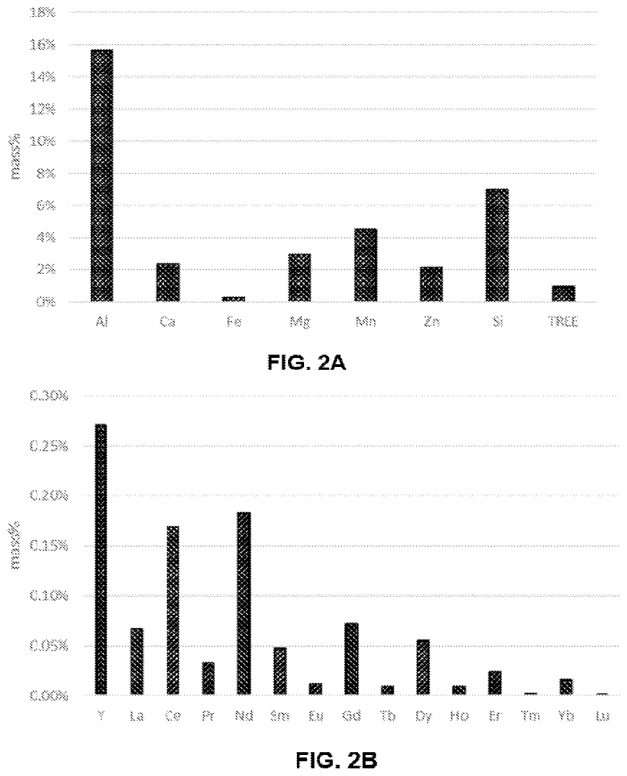

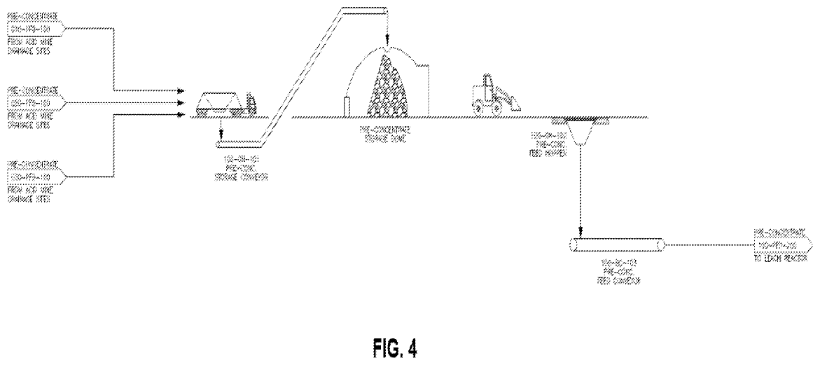

Referring now to FIGS. 1A-1B, which show aspects of a disclosed process 100 for preparation of a pregnant leach solution from an AMD-derived pre-concentrate. FIG. 1A shows a general process flow for the disclosed process for preparation of a pregnant leach solution from an AMD-derived pre-concentrate. FIG. 1B shows a more particular process flow for the disclosed process for preparation of a pregnant leach solution from an AMD-derived pre-concentrate. Briefly, an AMD-derived pre-concentrate is provided in step 10202 to a suitable acid leaching reactor or vessel, to which is added an acid in step 10201 in a controlled mass-to-volume ratio, i.e., ratio of the mass of pre-concentrate to volume of acid as discussed above. The mixing of an an AMD-derived pre-concentrate with an acid in the acid leaching reactor forms a slurry, i.e., an acid leached solution. Further details of a disclosed process for preparation of a pregnant leach solution from an AMD-derived pre-concentrate are also shown in FIGS. 4-10.

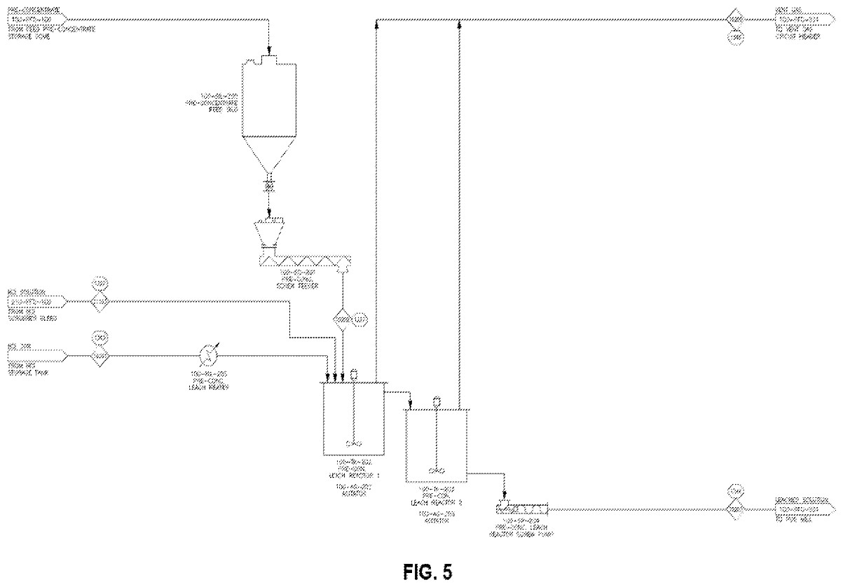

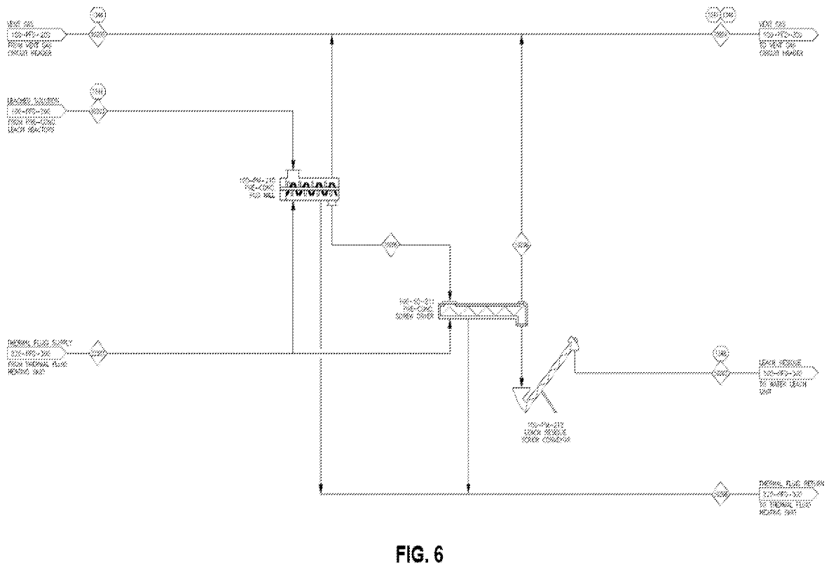

The acid leached solution can be conveyed to a suitable mixing apparatus via step 10203, e.g., a pug mill (see FIGS. 5-6), from which gases comprising acid vapor, e.g., hydrochloric acid vapor if the acid used in 10201 is hydrochloric acid, are vented and conveyed to a scrubber to recover acid in the gases. The mixed slurry obtained from mixing apparatus, e.g., a pug mill, can then be conveyed to a dryer, e.g., a screw dryer. In FIGS. 1A-1B, the mixing of the slurry and drying are shown as a single step, but as described, these are separable into discrete steps and apparatuses.

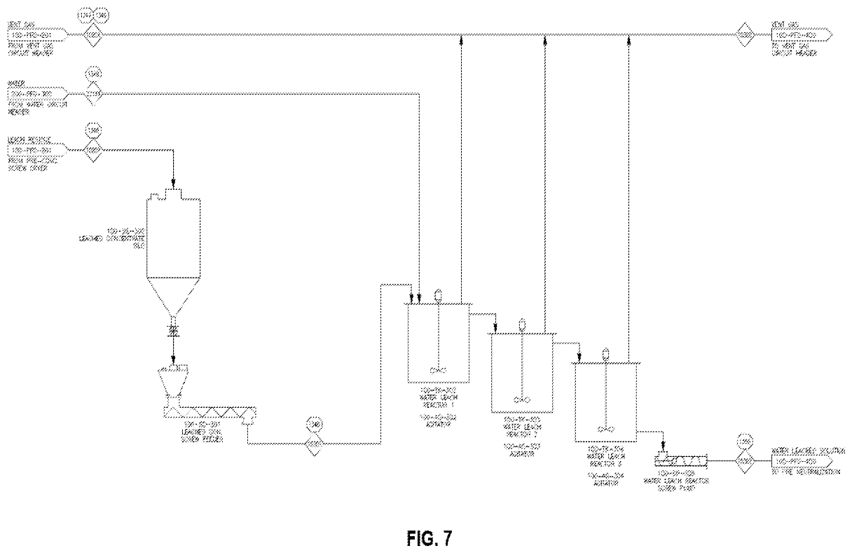

The dried solid obtained in the preceding step can be transferred to water leaching reactor in step 10207. The conveyance may further comprise additional steps and components (see FIG. 7), e.g., conveying to a leached concentrate silo, and then transferred from the leached concentrate silo via a screw feeder to the water leaching reactor or vessel. The water leaching reactor may comprise a plurality of water leaching reactors which may be connected in parallel or in series. The dried solid in the water leaching reactor is then mixed with water to form a water leached solution.

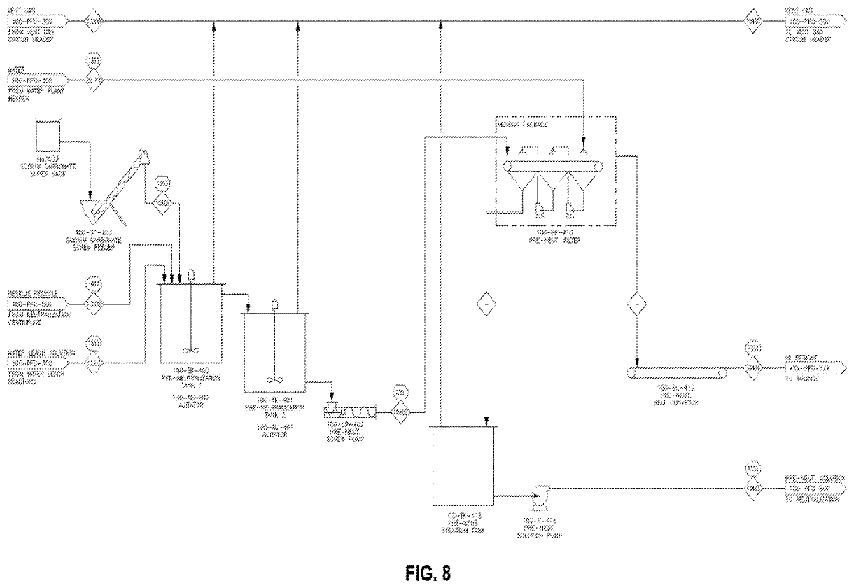

Following mixing in the water leaching reactor, the water leached solution can be pumped to a pre-neutralization tank in step 10302. In the pre-neutralization tanks, the water leached solution is mixed with a base as described herein above, thereby forming a pre-neutralization solution. The base can be provided as a solid from a solid reservoir, e.g., as shown in FIG. 8 a sodium carbonate super sack, that is conveyed to the pre-neutralization tanks via a screw feeder in a controlled mass-to-volume ratio, i.e., ratio of the mass of pre-concentrate to mass of base as discussed above. The pre-neutralization tanks may comprise a plurality of pre-neutralization tanks which may be connected in parallel or in series. The pre-neutralization solution can be conveyed, e.g., a screw pump, to a solid-liquid separator, e.g., a pre-neutralization filter apparatus. In FIGS. 1A-1B, the pre-neutralization and filtration steps are shown as a single step, but as described and as shown in FIG. 8, these are separable into discrete steps and apparatuses.

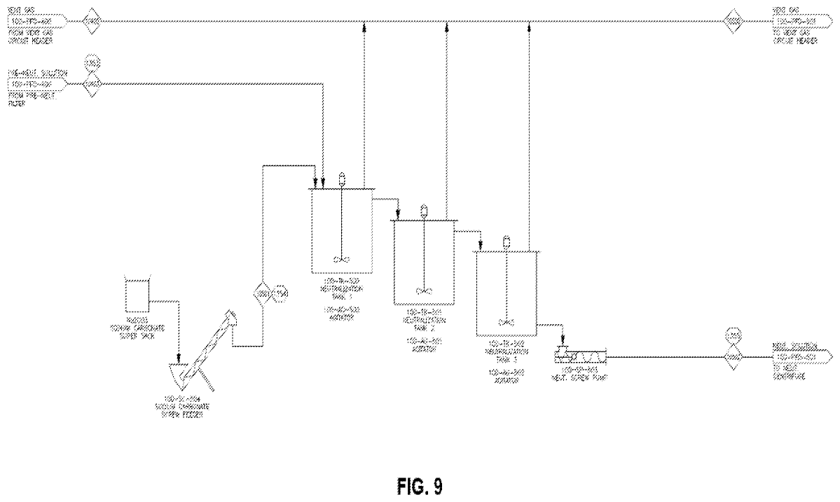

The filtrate from the foregoing is conveyed via step 110 to a neutralization tank, e.g., using a pump, and the solid retained on the filter is sent to tailings in step 10404. In the neutralization tanks, the pre-neutralization solution is mixed with a base as described herein above, thereby forming a neutralization solution. The base can be provided in step 10401 as a solid from a solid reservoir, e.g., as shown in FIG. 9, a sodium carbonate super sack, that is conveyed to the pre-neutralization tanks via a screw feeder in a controlled mass-to-volume ratio, i.e., ratio of the mass of pre-concentrate to mass of base as discussed above, to achieve a target pH. The target pH is determined by how the pregnant leach solution will be further processed downstream. The neutralization tanks may comprise a plurality of neutralization tanks which may be connected in parallel or in series.

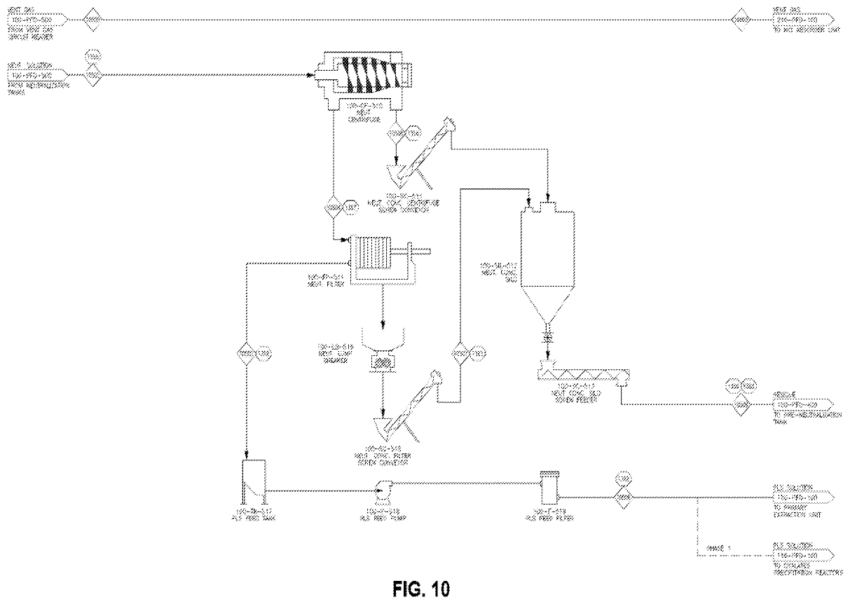

The neutralization solution is conveyed, e.g., using a screw pump, to a solid-liquid separator in step 10502. As shown FIGS. 1A-1B, the solid-liquid separator can be a centrifuge (see also FIGS. 6-7). The liquid removed following centrifugation can be subjected to further treatment using solid-liquid separator, e.g., a filtration device. In FIGS. 1A-1B, the centrifugation and filtration steps are shown as a single step, but as described and as shown in FIG. 10, these are separable into discrete steps and apparatuses. Following filtration, the solids obtained as a centrifuged solid and/or as solids retained on the filter can be combined in a suitable tank or silo, e.g., a neutralization concentrate silo as shown in FIG. 10, and recycled back into the pre-neutralization tanks in step 10509 for further processing and recovery as shown in FIG. 10. The filtrate obtained and removed in step 10506 can be subject to further filtration as appropriate (see step 10505 in FIG. 10) or used directly, but the filtrate—either used directly or further filtered—is the disclosed pregnant leach solution and can be subjected to further processing and enrichment of REE/CMs.

### D. ASPECTS

The following listing of exemplary aspects supports and is supported by the disclosure provided herein.

Aspect 1. A method for preparing a pregnant leach solution, the method comprising: providing a pre-concentrate; adding an acid to the pre-concentrate; mixing the acid and the pre-concentrate thereby forming an acid leached solution; adding water to the acid leached solution; mixing the water and the acid leached solution, thereby forming a water leached solution; adding a pre-neutralization base to the water leached solution thereby forming a pre-neutralization solution; separating the pre-neutralization solution into a pre-neutralization solids material and a pre-neutralization liquid; adding a neutralization base to the pre-neutralization liquid thereby forming a neutralization solution; and separating the neutralization solution into a neutralization solids material and a pregnant leach solution, thereby providing the pregnant leach solution.

Aspect 2. The method of Aspect 1, wherein the pre-concentrate is obtained from processing of acid mine drainage.

Aspect 3. The method of Aspect 2, wherein the acid mine drainage is associated with a coal mine, a hard rock mine, or combinations thereof.

Aspect 4. The method of Aspect 2, wherein the acid mine drainage comprises raw acid mine drainage (AMD), an AMD precipitate (AMDp), an enriched AMD precipitate (eAMDp), or combinations thereof.

Aspect 5. The method of any one of Aspect 1-Aspect 4, wherein the pre-concentrate comprises lanthanum, cerium, praseodymium, neodymium, promethium, samarium, europium, gadolinium, terbium, dysprosium, holmium, erbium, thulium, ytterbium, lutetium, scandium, and yttrium.

Aspect 6. The method of any one of Aspect 1-Aspect 5, wherein the pre-concentrate is a solid pre-concentrate material.

Aspect 7. The method of Aspect 6, wherein the solid pre-concentrate material comprises less than about 10 wt % moisture.

Aspect 8. The method of Aspect 6 or Aspect 7, wherein the solid pre-concentrate material comprises from about 1000 mg TREE to about 50000 mg TREE per kg of solid pre-concentrate material.

Aspect 9. The method of Aspect 8, wherein the solid pre-concentrate material comprises from about 1000 mg TREE to about 40000 mg TREE per kg of solid pre-concentrate material.

Aspect 10. The method of Aspect 8, wherein the solid pre-concentrate material comprises from about 1000 mg TREE to about 30000 mg TREE per kg of solid pre-concentrate material.

Aspect 11. The method of Aspect 8, wherein the solid pre-concentrate material comprises from about 3000 mg TREE to about 35000 mg TREE per kg of solid pre-concentrate material.

Aspect 12. The method of any one of Aspect 1-Aspect 5, wherein the pre-concentrate is pre-concentrate solution.

Aspect 13. The method of Aspect 12, wherein pre-concentrate solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 5 mg/L to about 500 mg/L.

Aspect 14. The method of Aspect 12, wherein pre-concentrate solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 50 mg/L to about 500 mg/L.

Aspect 15. The method of Aspect 12, wherein pre-concentrate solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 100 mg/L to about 500 mg/L.

Aspect 16. The method of any one of Aspect 12-Aspect 15, wherein iron is present at a concentration less than or equal to about 25 mg/L.

Aspect 17. The method of any one of Aspect 12-Aspect 16, wherein thorium and uranium are present in an aggregate concentration of less than about 1 mg/L.

Aspect 18. The method of any one of Aspect 12-Aspect 17, wherein pre-concentrate solution is substantially dried prior to the providing and the addition of the acid.

Aspect 19. The method of Aspect 17, wherein the pre-concentrate solution is substantially dried to obtain a solid pre-concentrate material; and wherein the solid pre-concentrate material comprises less than about 10 wt % moisture.

Aspect 20. The method of any one of Aspect 1-Aspect 19, wherein the acid is a mineral acid.

Aspect 21. The method of Aspect 20, wherein the mineral acid is selected from perchloric acid, hydrochloric acid, nitric acid, sulfuric acid, and combinations thereof.

Aspect 22. The method of Aspect 20 or Aspect 21, wherein the mineral acid is hydrochloric acid.

Aspect 23. The method of any one of Aspect 1-Aspect 22, wherein the acid has a concentration greater than or equal to about 8 M.

Aspect 24. The method of Aspect 23, wherein the acid has a concentration greater than or equal to about 9 M.

Aspect 25. The method of Aspect 23, wherein the acid has a concentration greater than or equal to about 10 M.

Aspect 26. The method of Aspect 23, wherein the acid has a concentration greater than or equal to about 11 M.

Aspect 27. The method of Aspect 23, wherein the acid has a concentration greater than or equal to about 12 M.

Aspect 28. The method of any one of Aspect 1-Aspect 27, wherein the pre-concentrate and acid have a ratio of from about 0.3 g pre-concentrate to 1 mL acid to about 0.7 g pre-concentrate to 1 mL acid.

Aspect 29. The method of Aspect 28, wherein the pre-concentrate and acid have a ratio of from about 0.4 g pre-concentrate to 1 mL acid to about 0.6 g pre-concentrate to 1 mL acid.

Aspect 30. The method of any one of Aspect 1-Aspect 29, wherein the acid leached solution is heated prior to forming the water leached solution.

Aspect 31. The method of Aspect 30, wherein the acid leached solution is heated from about 65° C. to about 95° C. for a period of time from about 15 minutes to about 120 minutes.

Aspect 32. The method of Aspect 31, wherein the acid leached solution is heated from about 75° C. to about 85° C. for a period of time from about 30 minutes to about 90 minutes.

Aspect 33. The method of any one of Aspect 1-Aspect 32, further comprising drying the acid leached solution.

Aspect 34. The method of any one of Aspect 1-Aspect 33, wherein the adding water to the acid leached solution comprises adding water in an amount of from about 1 ml water: 0.01 gm pre-concentrate to about 1 mL water: 0.20 gm pre-concentrate.

Aspect 35. The method of Aspect 34, wherein the adding water to the acid leached solution comprises adding water in an amount of from about 1 ml water: 0.05 gm pre-concentrate to about 1 mL water: 0.15 gm pre-concentrate.

Aspect 36. The method of any one of Aspect 1-Aspect 35, wherein the pre-neutralization base is selected from ammonium carbonate, ammonia or ammonium hydroxide, anhydrous sodium carbonate (Na₂CO₃, soda ash), hydrated sodium carbonate (Na₂CO₃·nH₂O, washing soda), sodium bicarbonate (NaHCO₃, baking soda), sodium hydroxide (NaOH, caustic soda), anhydrous potassium carbonate (K₂CO₃), hydrated potassium carbonate (K₂CO₃·nH₂O), potassium bicarbonate (KHCO₃), potassium hydroxide (KOH), calcium oxide (CaO, lime, quicklime, or burnt lime), calcium hydroxide (Ca(OH)₂, hydrated lime or slaked lime), and combinations thereof.

Aspect 37. The method of Aspect 36, wherein the pre-neutralization base is selected from anhydrous sodium carbonate (Na₂CO₃, soda ash), hydrated sodium carbonate (Na₂CO₃·nH₂O, washing soda), sodium bicarbonate (NaHCO₃, baking soda), and combinations thereof.

Aspect 38. The method of any one of Aspect 1-Aspect 37, wherein the pre-neutralization base is added in an amount to substantially precipitate aluminum and/or iron from the water leached solution.

Aspect 39. The method of any one of Aspect 1-Aspect 38, wherein the neutralization base is selected from ammonium carbonate, ammonia or ammonium hydroxide, anhydrous sodium carbonate (Na₂CO₃, soda ash), hydrated sodium carbonate (Na₂CO₃·nH₂O, washing soda), sodium bicarbonate (NaHCO₃, baking soda), sodium hydroxide (NaOH, caustic soda), anhydrous potassium carbonate (K₂CO₃), hydrated potassium carbonate (K₂CO₃·nH₂O), potassium bicarbonate (KHCO₃), potassium hydroxide (KOH), calcium oxide (CaO, lime, quicklime, or burnt lime), calcium hydroxide (Ca(OH)₂, hydrated lime or slaked lime), and combinations thereof.

Aspect 40. The method of any one of Aspect 1-Aspect 39, wherein the separating the pre-neutralization solution into a pre-neutralization solids material and a pre-neutralization liquid comprises use of filtration.

Aspect 41. The method of any one of Aspect 1-Aspect 40, wherein the separating neutralization solid material from a pregnant leach solution comprises sedimentation, filtration, centrifugation, and combinations thereof.

Aspect 42. The method of Aspect 41, wherein the separating the neutralization solution into a neutralization solids material and a pregnant leach solution comprises steps of: centrifugation of the neutralization solution; removal of the liquid following centrifugation; and filtration of the liquid removed following centrifugation; thereby providing the pregnant leach solution.

Aspect 43. The method of Aspect 42, wherein the pregnant leach solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration.

Aspect 44. The method of Aspect 43, wherein the total rare earth concentration is about 5 mg/L to about 500 mg/L.

Aspect 45. The method of Aspect 43, wherein the total rare earth concentration is about 50 mg/L to about 500 mg/L.

Aspect 46. The method of Aspect 43, wherein the total rare earth concentration is about 100 mg/L to about 500 mg/L.

Aspect 47. A pregnant leach solution prepared by the method of any one of Aspect 1-Aspect 46.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### E. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

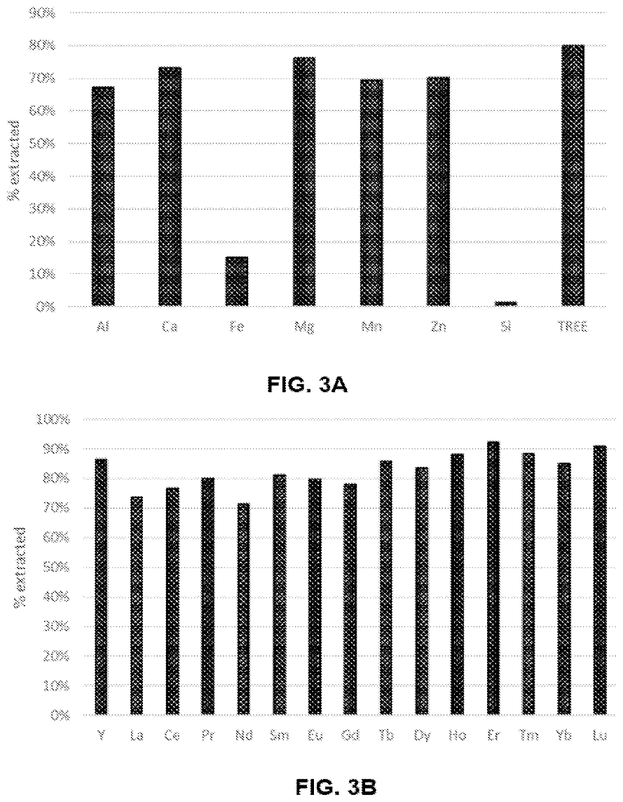

Preparation of Pregnant Leach Solution. The disclosed methods were used to prepare a pregnant leach solution from a pre-concentrate. Briefly, a pre-concentrate was mixed with concentrated (37 wt %) hydrochloric acid in a ratio of 1 g pre-concentrate to 2 mL HCl. The pre-concentrate comprised approximately 28 wt % gangue metals, 7 wt % silicon, and 1 wt % total rare earth elements (TREE; see FIG. 3A). The specific levels of the components of the TREE are given in FIG. 3B. Upon addition of HCl, the resulting mixture became hot with copious gas evolution. Without wishing to be bound by a particular theory, it is believed that the exothermic reaction comprises reaction of hydrochloric acid with manganese oxide from the pre-concentrate to form chlorine gas. Further, without wishing to be bound by a particular theory, it is believed that in the strongly acidic environment of the hydrochloric acid-pre-concentrate mixture that silicates present from the pre-concentrate polymerize to form an insoluble precipitate. After the gas evolution stopped, the dark green mixture was heated at 80° C. for an hour to remove excess hydrochloric acid.

After cooling to room temperature, water was added in a ratio of 10 mL water per gram solid pre-concentrate material preparation and the mixture stirred. The green color changed to yellow and a yellow-brown solid formed. The mixture comprising a liquid phase and precipitate was processed by centrifugation followed by filtration of the supernatant obtained from centrifugation. Analysis of the solution showed that the silicon concentration was 100 mg/L. Based on mass balance calculations, about 60%-80% of gangue elements (Al, Ca, Fe, Mg, Mn, Zn), 1% of the silicates (FIG. 4A), and about 70%-90% of the TREEs present in the solid pre-concentrate material preparation were obtained in the pregnant leach solution. The amounts of the various components of the TREE in the pregnant leach solution are as shown in FIG. 4B.

It was noted that when the concentrated (37%) hydrochloric acid was added to a large mass of solid pre-concentrate material preparation in a 2 mL acid to 1 g pre-concentrate ratio as describe above, the resulting mixture had high viscosity in which mixing became difficult. However, reversing the addition sequence, i.e., adding the solid pre-concentrate material preparation to the acid, resulted in more uniform wetting and mixing of the solid and liquid. This method of addition was further improved, i.e., achieving enhanced uniformity of wetting and mixing of pre-concentrate and acid, by adding portions of acid and solids alternately to the container while continuously stirring. When water was added in a ratio of 10 ml of water to 1 g of solid pre-concentrate material, the resulting mixture contained a gel-like precipitate that was not filterable. However, liquid was readily separated from the precipitate in the mixture by centrifugation. The supernatants from the centrifugation step were then filtered.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A method for preparing a pregnant leach solution, the method comprising: providing a pre-concentrate;
adding an acid to the pre-concentrate;
mixing the acid and the pre-concentrate thereby forming an acid leached solution;
adding water to the acid leached solution;
mixing the water and the acid leached solution, thereby forming a water leached solution;
adding a pre-neutralization base to the water leached solution thereby forming a pre-neutralization solution;
separating the pre-neutralization solution into a pre-neutralization solids material and a pre-neutralization liquid;
adding a neutralization base to the pre-neutralization liquid thereby forming a neutralization solution; and
separating the neutralization solution into a neutralization solids material and a pregnant leach solution, thereby providing the pregnant leach solution.

2. The method of claim 1, wherein the pre-concentrate is obtained from processing of acid mine drainage.

3. The method of claim 2, wherein the acid mine drainage is associated with a coal mine, a hard rock mine, or combinations thereof.

4. (canceled)

5. The method of claim 1, wherein the pre-concentrate comprises lanthanum, cerium, praseodymium, neodymium, promethium, samarium, europium, gadolinium, terbium, dysprosium, holmium, erbium, thulium, ytterbium, lutetium, scandium, and yttrium.

6. The method of claim 1, wherein the pre-concentrate is a solid pre-concentrate material.

7. The method of claim 6, wherein the solid pre-concentrate material comprises less than about 10 wt % moisture.

8. The method of claim 6, wherein the solid pre-concentrate material comprises from about 1000 mg TREE to about 50000 mg TREE per kg of solid pre-concentrate material.

9. (canceled)

10. (canceled)

11. (canceled)

12. (canceled)

13. The method of claim 12, wherein the pre-concentrate is a pre-concentrate solution; and wherein pre-concentrate solution comprises lanthanum, cerium, praseodymium, neodymium, promethium, samarium, europium, gadolinium, terbium, dysprosium, holmium, erbium, thulium, ytterbium, lutetium, scandium, and yttrium; wherein each of the foregoing is independently present at a concentration and sum of each concentration is a total rare earth element concentration; and wherein the total rare earth concentration is about 5 mg/L to about 500 mg/L.

14. (canceled)

15. (canceled)

16. The method of claim 12, wherein iron is present at a concentration less than or equal to about 25 mg/L.

17. The method of claim 12, wherein thorium and uranium are present in an aggregate concentration of less than about 1 mg/L.

18. The method of claim 12, wherein pre-concentrate solution is substantially dried prior to the providing and the addition of the acid.

19. The method of claim 17, wherein the pre-concentrate solution is substantially dried to obtain a solid pre-concentrate material; and wherein the solid pre-concentrate material comprises less than about 10 wt % moisture.

20. The method of claim 1, wherein the acid is a mineral acid.

21. (canceled)

22. (canceled)

23. The method of claim 1, wherein the acid has a concentration greater than or equal to about 8 M.

24. (canceled)

25. (canceled)

26. (canceled)

27. (canceled)

28. The method of claim 1, wherein the pre-concentrate and acid have a ratio of from about 0.3 g pre-concentrate to 1 mL acid to about 0.7 g pre-concentrate to 1 mL acid.

29. (canceled)

30. The method of claim 1, wherein the acid leached solution is heated prior to forming the water leached solution.

31. (canceled)

32. (canceled)

33. The method of claim 1, further comprising drying the acid leached solution.

34. The method of claim 1, wherein the adding water to the acid leached solution comprises adding water in an amount of from about 1 ml water: 0.01 gm pre-concentrate to about 1 ml water: 0.20 gm pre-concentrate.

35. (canceled)

36. (canceled)

37. (canceled)

38. (canceled)

39. (canceled)

40. The method of claim 1, wherein the separating the pre-neutralization solution into a pre-neutralization solids material and a pre-neutralization liquid comprises use of filtration; and wherein the separating neutralization solid material from a pregnant leach solution comprises sedimentation, filtration, centrifugation, and combinations thereof.

41. (canceled)

42. (canceled)

43. (canceled)

44. (canceled)

45. (canceled)

46. (canceled)

47. A pregnant leach solution prepared by the method of claim 1.
